(19) United States
(12) Patent Application Publication
(10) Pub. No.: US 2007/0235623 A1
(43) Pub. Date: Oct. 11, 2007

(54) Method and apparatus for regulating hydrostatic pressure

(76) Inventors: Shai Amisar, Tel Aviv (IL); Ronen Radomski, Haifa (IL)

Correspondence Address: Edward Langer;c/o Shiboleth, Yisraeli, Roberts, Zisman & Co., 60th Floor, 350 Fifth Avenue, New York, NY, 10118, US

(21) Appl. No.: 11/397,909

(22) Filed: Apr. 5, 2006

(51) Int. Cl. F16M 13/00

(52) U.S. Cl. 248/560

(57) ABSTRACT

The present invention is directed to a pressure equalizing means for regulating the hydrostatic pressure of an infusion liquid by attaching the liquid container, containing the infusion liquid, to a static point via a resilient member which is adapted to maintain the level of the liquid in the liquid container in a substantially constant height relative to the static point.

### FIELD OF THE INVENTION

The present invention relates to a variable method and apparatus for regulating hydrostatic pressure of an infusion fluid. More particularly, the invention relates to an infusion bag or pole with a hydrostatic pressure equalizing means.

### BACKGROUND OF THE INVENTION

It is known in the art to provide intravenous delivery of fluids and medicaments to a subject. Intravenous therapy is generally carried out by feeding a medicament together with or in the absence of saline solution from a bag or other supply source. The rate of delivery is generally controlled using a valve associated with a flow-monitoring device. Regardless of the flow monitoring device or the valve used, the hydrostatic pressure that causes the liquid to flow change as the container is emptied and can loose up to 30% of its starting state.

Known gravitational infusion containers have several drawbacks, including the decrease of pressure as the container is emptied. The standard procedure requires the container to be hanged 80 cm above the patients head, producing about 0.08 Bar of pressure. Infusion liquid container can have up to 30 cm of liquid which causes a change of pressure of up to ⅜ or almost 38% between start and finish. This physical phenomenon is limiting the use of gravitational based infusion devices and whenever the administration of medication has to be under controlled rate, the use of electronic pumps are inevitable, increasing the cost of treatment tens fold and eliminating the ability of low budgets facilities to precisely control the administration of IV fluids to their patients.

Moreover, the conventional use of different flow regulating devices is hardly accurate as the influx pressure is constantly changing. The change in the incoming pressure is also increasing the margin of error of the more sophisticated electronic pumps and other flow producing devices.

An understanding of the state of the art may be obtained with reference to the product IV-flow of Varori international of South-Africa (www.varory.com) this device has been able to solve the fall in hydrostatic pressure but is very expensive and it cannot be incorporated into the standard infusion containers or the hanging poles.

The methods described above have solved the problem of the change in hydrostatic pressure but resulting a huge increase of price of the infusion set. The Varori international has a price tag of 1.83 US$ per set, increasing the price of the sets at the 400% level. An increase that is unacceptable by the already under-budget health system. More over, the product is changing the way the users are used to operate by and hence, require new training and separate purchasing of this item. Therefore there is a need for a cheap solution that overcomes the above mentioned problems.

It is therefore an object of the present invention to provide a cheap hydraulic pressure equalizer.

It is another object of the present invention to provide a cheap hydraulic pressure equalizer that might be installed integrally or as an add-on on an infusion bag.

It is another object of the present invention to provide a cheap hydraulic pressure equalizer that might be installed integrally or as an add-on on an infusion pole if required.

Other objects and advantages of the invention will become apparent as the description proceeds.

### SUMMARY OF THE INVENTION

In general, the present invention is directed to pressure equalizing means utilizing an elastic/resilient material (or means) that adjusts the height of a liquid level of a liquid contained in a liquid container (e.g., infusion bag) as its weight is decreased during gradual release (e.g., infusion) thereof.

The term infusion liquid is used herein to refer to any suitable liquid which is gradually released from a liquid container, such as an infusion bag. The term static point is used herein to refer to a stationary spot or support capable of substantially maintaining a fixed height above the ground.

In one aspect the present invention is directed to pressure equalizing means for maintaining substantially constant hydrostatic pressure of an infusion liquid contained in a liquid container, wherein a resilient member is used to attach the liquid container to a static point, wherein said resilient member is adapted to maintain the level of the liquid contained in said liquid container in a substantially constant height relative to said static point.

Optionally, the resilient member is an elastic band. Additionally or alternatively, the resilient member may be an integral part of the liquid container. Advantageously, the resilient member may be implemented by a spring or a movable arm.

### BRIEF DESCRIPTION OF THE DRAWINGS

In the drawings:

FIG. 1 schematically illustrates the pressure equalizer of the invention in which the elevating element employs an elastic material; and

FIG. 2 schematically illustrates another preferred embodiment of the invention in which the elevating element employs a pull spring; and

FIG. 3 schematically illustrates another preferred embodiment of the invention in which pressure equalizer is integral to the infusion bag; and

FIG. 4 schematically illustrates another preferred embodiment of the invention in which pressure equalizer is integral to the infusion pole; and

FIGS. 5A to 5C schematically illustrates the position of the infusion set at the start middle and end of the use of the infusion fluid container; and

FIGS. 6A and 6B schematically illustrates another preferred embodiment of the invention in which pressure equalizer is integral to the infusion pole with a moving arm and a pull spring; and

FIGS. 7A and 7B schematically illustrates another preferred embodiment of the invention in which pressure equalizer is integral to the infusion pole with a moving arm and a push spring; and

FIGS. 8A and 8B schematically illustrates the change in the fluid flow when a regular system is used and when the said invention is employed.

### DETAILED DESCRIPTION OF PREFERRED EMBODIMENTS

The present invention provides a method and a device that eliminates the changes in Hydrostatic pressure as the infusion container empties and the height of the liquid lowers. More particularly, the invention relates to an infusion bag or pole with a hydrostatic pressure equalizing means utilizing an elastic/resilient material (or means) that adjusts the height of the infusion as its weight is decreased during the infusion. The device of the present invention is compact, inexpensive, and provides an immediate cancellation of the pressure changes without any requirements or attentions from the operator.

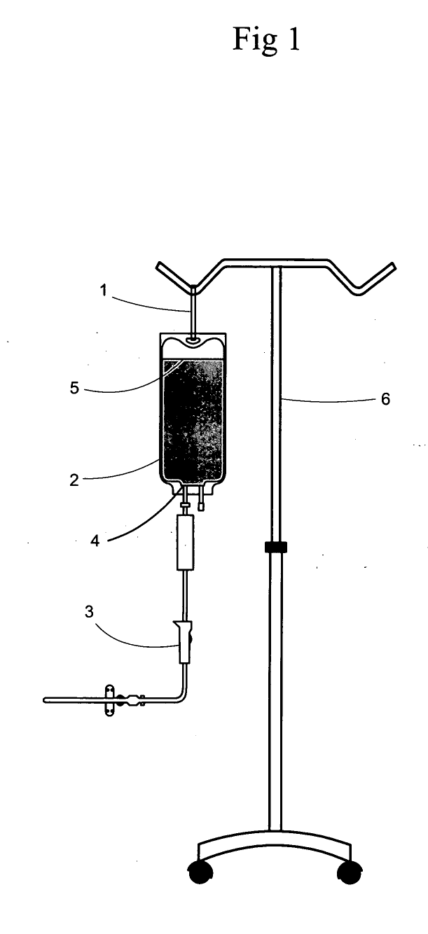

FIG. 1 schematically illustrates the pressure equalizer of the invention in which the elevating element 6 connects to an elastic band 1. The elastic band is connected to the upper side of the fluid container 2.

When infusion flow regulator 3 opens, fluid start to flow out of the fluid container 2 through fluid outlet 4, the total weight of the fluid container 2 is reduced, allowing the constant elevating pressure produced by the elastic band 1, to pull the complete container 2 upwards in a precise ratio of the weight lost. This pressure equalizer keeps the liquid level 5 at the same height during the complete infusion use until completely empty.

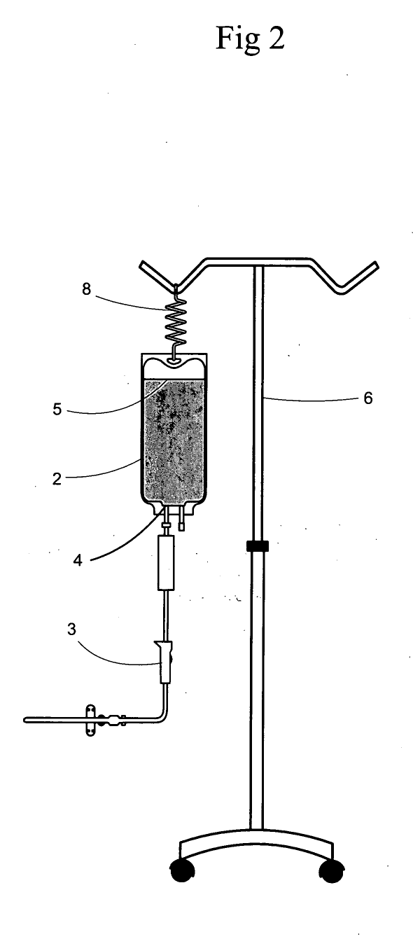

As previously described hereinabove with reference to FIG. 1, in FIG. 2 a similar equalizing process is deployed using a pull spring 8 instead of elastic band (1, in FIG. 1).

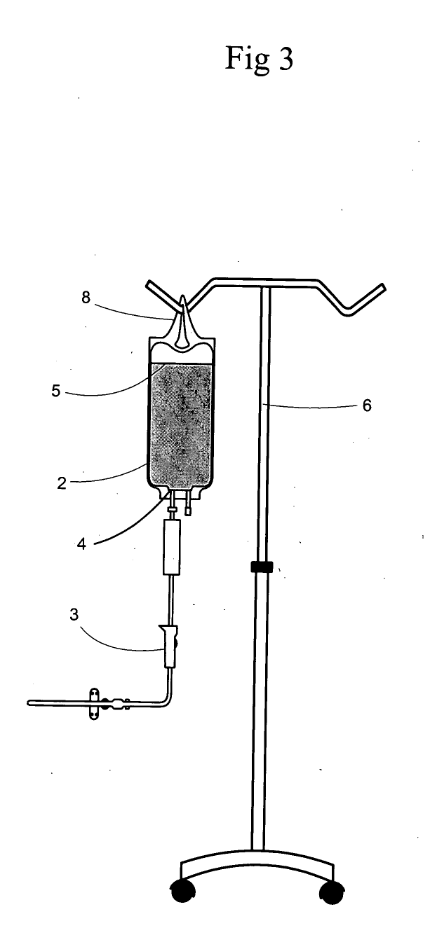

A further preferred embodiment in shown in FIG. 3, in which the elastic band 8 is produced as integral part of the infusion bag 2. This preferred embodiment can be achieved during the manufacturing process by molding, die stamping, gluing, welding or otherwise attaching the elastic band to the container before or after filling it with the infusion liquid.

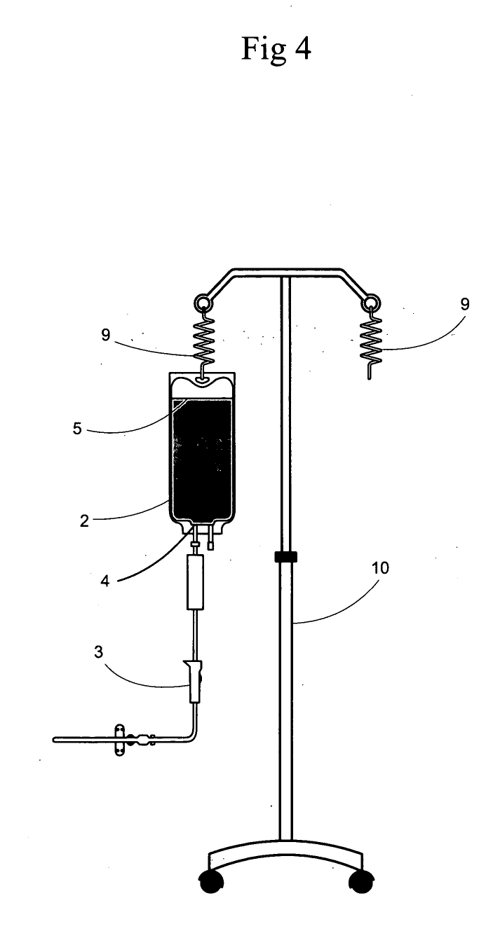

A further preferred embodiment in shown in FIG. 4, in which spring 9 is provided as an integral part of the infusion elevating pole 10. This can be achieved during the manufacturing process by gluing, welding bolting or otherwise attaching the spring to the elevating pole before or after its supply to the end user.

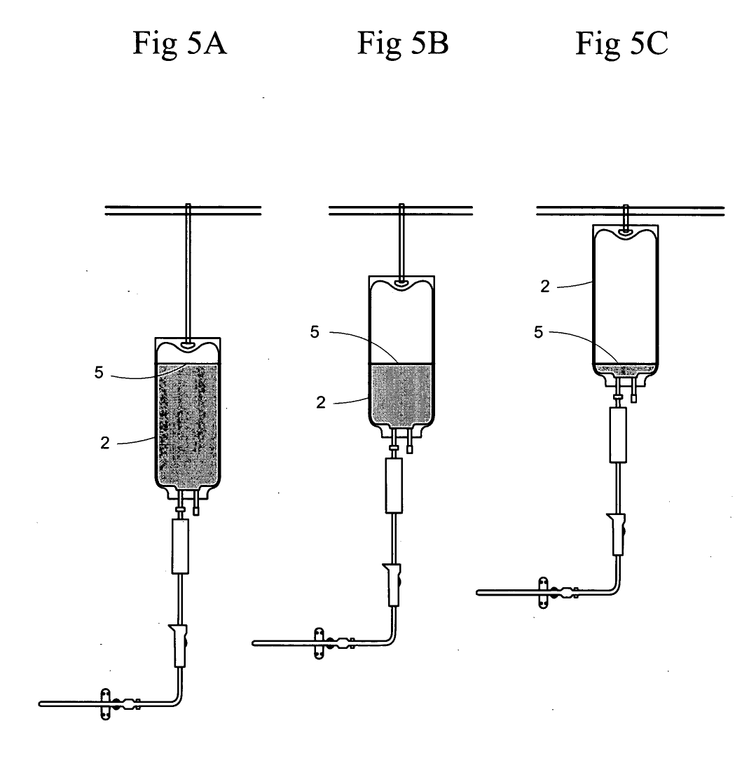

As previously described with reference to FIG. 1, in FIGS. 5A, 5B and 5C the infusion fluid level 5 is at the same height although the contents of the infusion container 2 has been emptied to some extant. FIG. 5A shows infusion container 2 at the beginning of the infusion process, FIG. 5B shows infusion container 2 at the in an intermediate state, and FIG. 5C shows infusion container 2 at the end of the infusion.

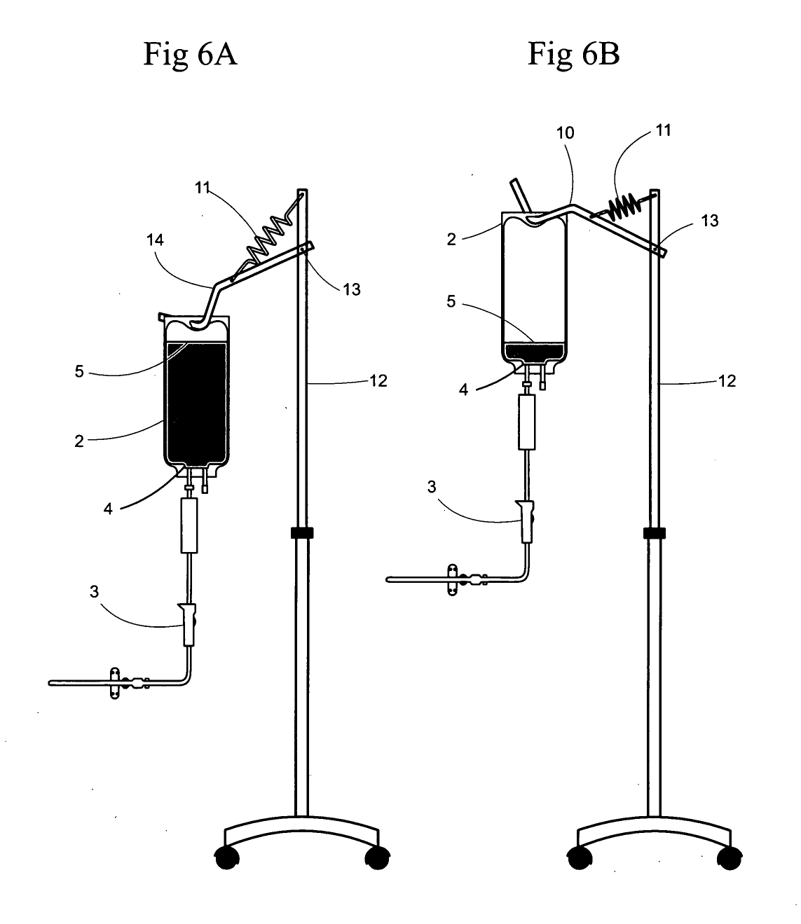

A further preferred embodiment in shown in FIGS. 6A and 6B, in which the spring 11 is connected to movable arm 14 and hanging pole 12. Movable arm 14 is connected by a pivot 13 to the hanging pole 12. When the infusion has started, the movable arm 14 is pulled up by the spring 11, as long as the infusion is running empty, keeping the fluid level 5, at the same height during the emptying process. FIG. 6A shows the state of infusion container 2 at the beginning of the infusion, and FIG. 6B shows the state of infusion container 2 in an intermediate state.

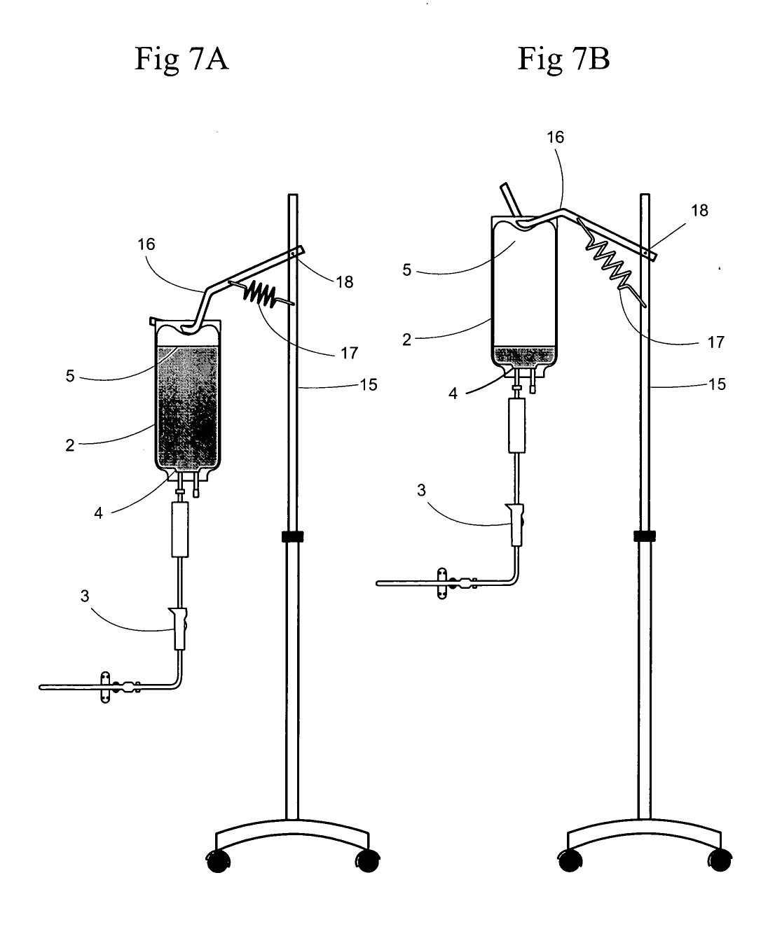

A further preferred embodiment in shown in FIGS. 7A and 7B, in which spring 17 is connected to movable arm 16 and hanging pole 15. Movable arm 16 is connected by a pivot 18 to the hanging pole 15. When the infusion has started, the movable arm 16 is pushed up by the spring 17, as long as the infusion is running empty, keeping the fluid level 5, at the same height during the emptying process.

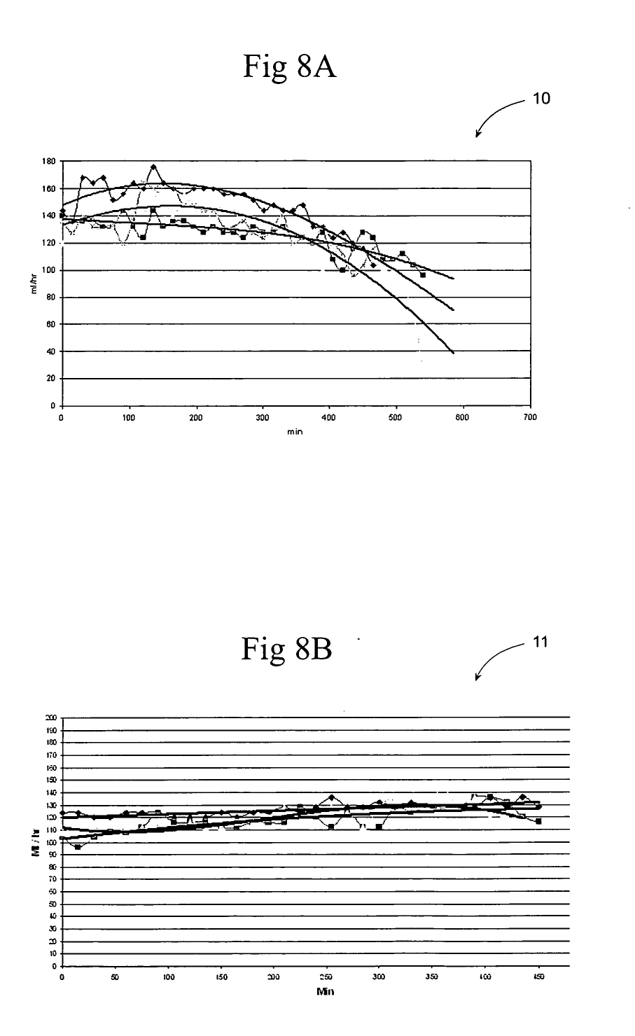

For the sake of clarity As previously described with reference to FIG. 1, FIG. 8A graph illustrates the hydraulic pressure changes generated when a standard infusion container and/or a standard elevating pole is used and FIG. 8B is a graph illustrating the hydraulic pressure changes generated when the pressure equalizing means of this invention are used.

The materials and methods used for constructing the various embodiments of the present invention are those routinely used in the manufacture of other springs and elastic bands, and well known to the skilled artisan in this field. Preferably, the elastic band is constructed from an elastic material (such as, for example, Silicon, latex . . . ) which can expand its length to the full height of the liquid in the liquid container at the weight of such a container. For example, an infusion bag of 1 L capacity has a liquid height of 28 cm. The required band or spring, ideally, will have to expand 28 cm when a force of 1 Kg is applied. Other measurements and ratios can be employed in accordance with the specific type of containers used. The elastic material is preferably made of a material such as latex or any other elastomeric polymer with the required physical properties.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. Pressure equalizing means for regulating the hydrostatic pressure of an infusion liquid, comprising a liquid container and a resilient member attaching said liquid container to a static point, wherein said resilient member is adapted to maintain the level of the liquid contained in said liquid container in a substantially constant height relative to said static point.

2. The pressure equalizing means according to claim 1, wherein the resilient member is an elastic band.

3. The pressure equalizing means according to claim 1, wherein the resilient member is and integral part of the liquid container.

4. The pressure equalizing means according to claim 1, wherein the resilient member is a spring.

5. The pressure equalizing means according to claim 1, wherein the resilient member is comprised from a spring and a movable arm.
